(19) United States
(12) Patent Application Publication
(10) Pub. No.: US 2015/0274080 A1
(43) Pub. Date: Oct. 1, 2015

(54) SUPPORTS FOR BOX OF TISSUES IN A VEHICLE

(71) Applicant: Richard TREMBLAY, St-Lambert-de-Lauzon (CA)

(72) Inventor: Richard TREMBLAY, St-Lambert-de-Lauzon (CA)

(21) Appl. No.: 14/225,118

(22) Filed: Mar. 25, 2014

(51) Int. Cl. B60R 7/04; B60R 11/00

(52) U.S. Cl. CPC B60R 7/04; B60R 11/00; B60R 2011/0028

(57) ABSTRACT

A set of moulded plastic holders to fix a box of tissues on the ceiling of a vehicle. The holders embrace the corners of the box, along with pins fixing the holders into the fabric of the ceiling of the cabin of vehicle. The holders provide anchor points on the ceiling surface; they take the triangular shape of the corners of the box on the three sides of the corners of the box. They are being held in position on the ceiling with pins inserted at a crossing angle to keep them from slipping. A cap is used in extension to the device; it folds on the side with the pins thus putting pressure on them in closed position pressing the pins against the ceiling. The cap is adding to the look by covering the pins. Elastic bands are used around the box to fit perfectly between two corresponding holders.

### FIELD OF THE INVENTION

The following invention belongs to the fields of supports used to hang boxes of tissues from the ceiling so the opening of the boxes is facing down, towards the passengers of the vehicle.

### PRIOR ART

The present invention refers to a previous Canadian application 2811234 filed on 2013 Mar. 25 by same inventor.

Our search among patents revealed some systems that caught our attention: CA 2,212,096 <<Tissue box holder>> from Said Iravanipour, filed on 5 Sep. 1997, shows a support to hang boxes of tissues in the passenger compartment of a vehicle. This support consists of a base along with straps. On one side of the base, a box of tissues is fixed and held by a set of straps and on the other side of the base some fastening means such as adhesive tape or screws are installed.

TW 201141732 <<Structure of tissue paper box holder for vehicle>> from Yang Ming-Shun [TW] published on 1 Dec. 2011, shows two magnetic mounts holding a box of tissues; each holder is facing the other and therefore the entire thickness of the box is held. A clip system allowing you to adjust the height of the holders as required; the supports are fixed on the ceiling with glue or Velcro.

### OBJECTIVES AND BENEFITS

There is a real need for supports of boxes of tissues in the vehicle market. More precisely, the following features must be found in the device: easily installed on the ceiling of any vehicle, suiting the vast majority of boxes of tissues, and holding them on the ceiling in such a position that the opening of the box is facing the passengers of the vehicle.

This support does not require any glue in order to be fixed on the ceiling of the vehicle. The glue to be used for a suitable adhesion to the fabric of the ceiling requires a specific room temperature as long as pressure and rubbing of the fingertips.

Holders designed for our invention come preferably in sets of four each of which forms readily around the four corners of the box. These holders take the shape of each of the corners of a box of tissues on the three sides of the corners of the box offering excellent flexibility and adaptability to the various formats of boxes of tissues on the market. A set of pins is to be used along with the holders in order to fix the device on the ceiling of the vehicle.

The pins are placed on a surface with holes in extension to the support. On each of the holders, two pins are preferably inserted at a crossing angle to reduce slippage which could cause the support to fall and the box of tissues. A cap ending with a hinged flap is found in extension to the surface where the pins are located; that cap can be folded towards the surface with the pins so that when it is closed, and blocked by fastening means, it is pressing against the pins, pressing them firmly against the ceiling to keep them from slipping and consequently prevent the device from moving. Moreover, it covers the pins which is adding to the look of the support.

An elastic band is used to surround the box of tissues and tighten it against the holders.

The present invention will be further understood from the following description with reference to the drawings.

### BRIEF DESCRIPTION OF DRAWING FIGURES

FIG. 1 showing a perspective view of a single support.

FIG. 2 showing a perspective view of the supports with a box of tissues.

FIG. 3 showing a perspective view of four supports with elastic bands.

FIG. 4 showing a perspective view of the items separately disclosed.

FIG. 5 showing a view of the support from underneath.

FIG. 6 representing an enlargement showing the supporting shoulder.

FIG. 7 showing an enlarged back view from a pin that has been inserted.

### DETAILED DESCRIPTION OF THE PREFERRED EMBODIMENTS

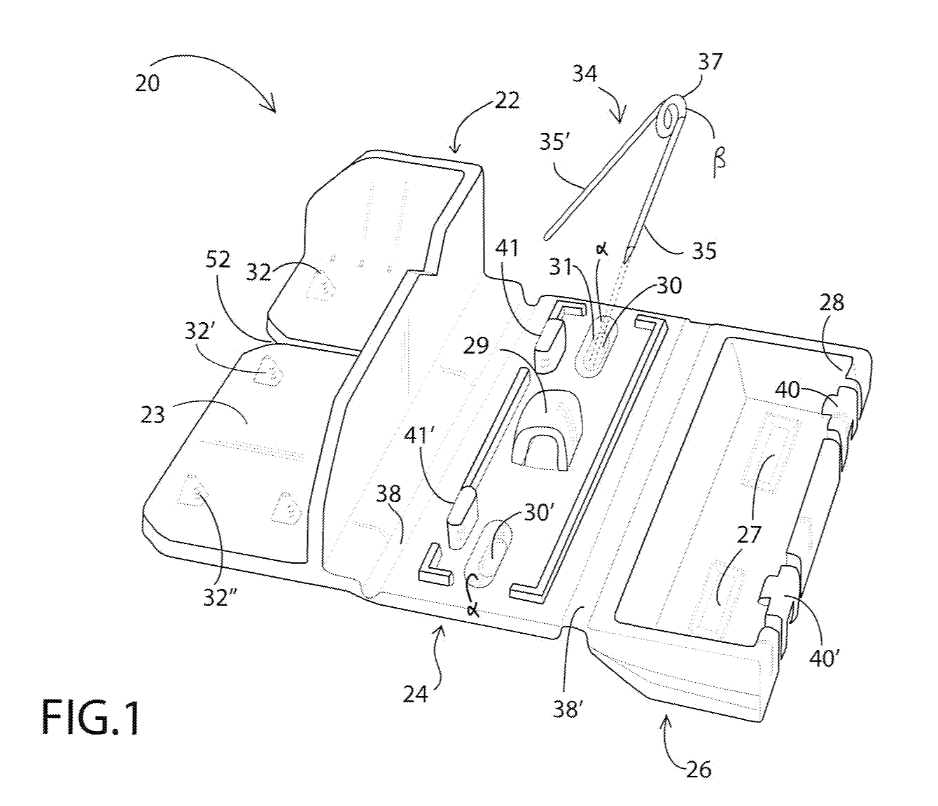

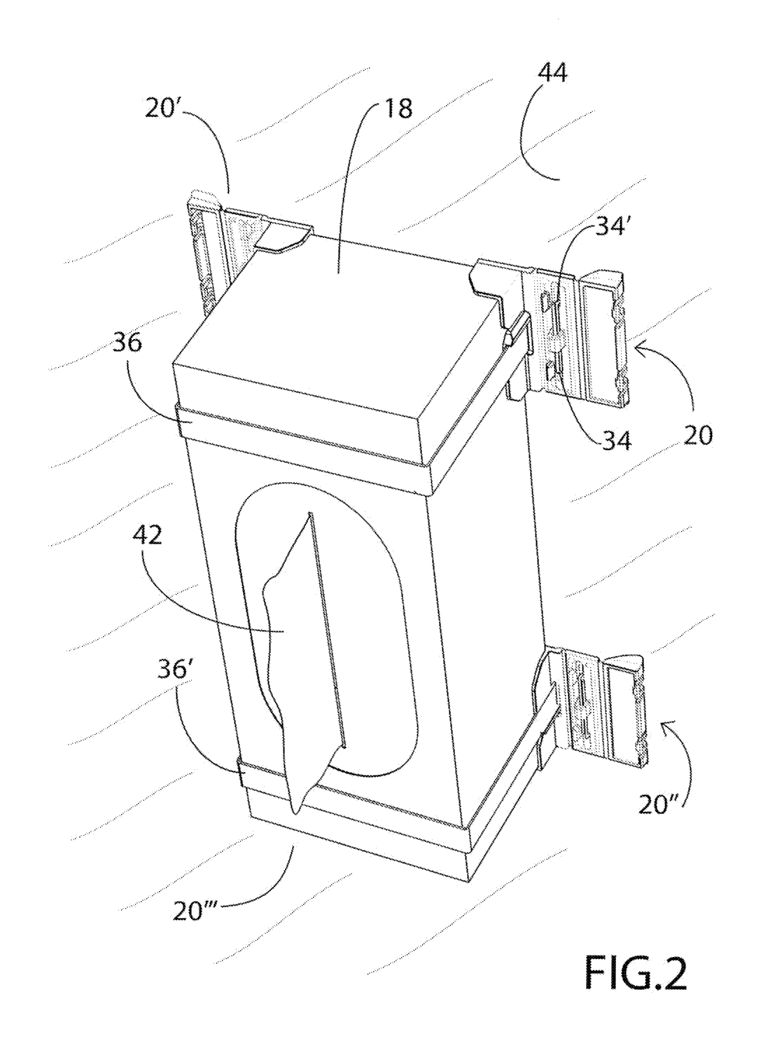

FIG. 1 is showing a support 20 consisting of a triangular wedge-shaped holder 22 so it can adjust to the corner of a box of tissues, it includes a tray 23 and the corner 22. In the tray a groove for the elastic 52 is allowing the insertion of an elastic band to tighten the box of tissues between two holders on the corners facing each other (as shown in FIG. 2).

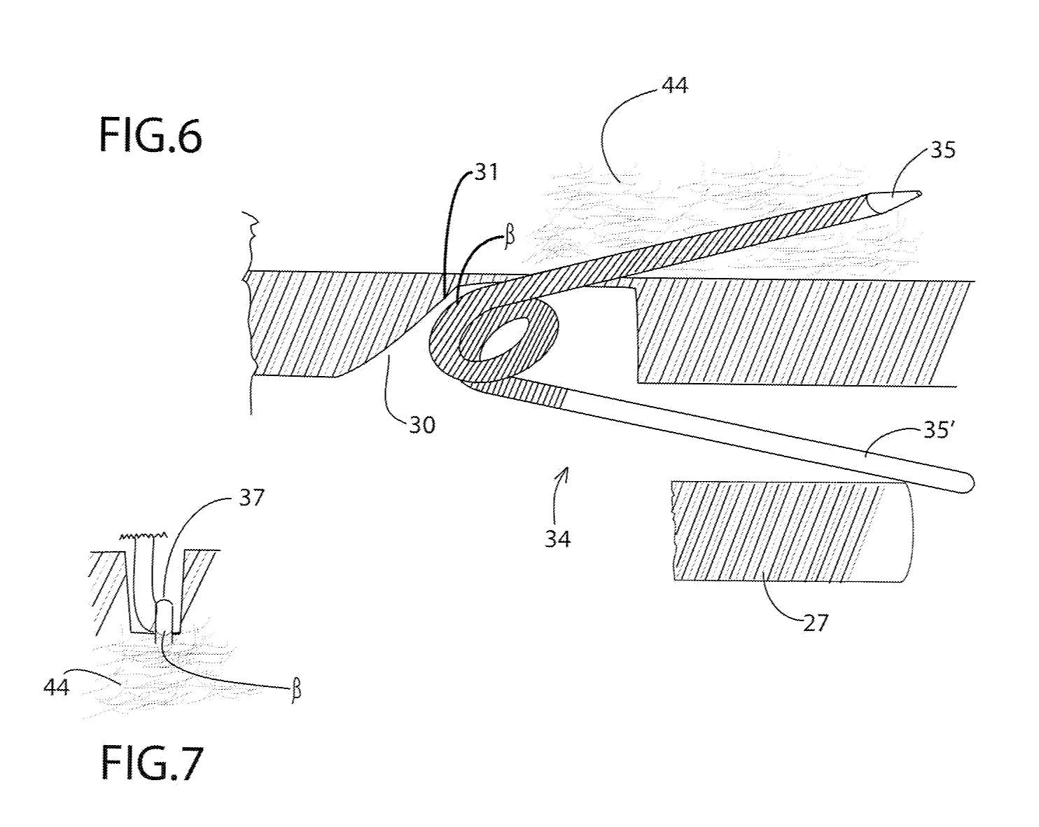

In addition to the wedge-shaped holder a surface 24 with holes 30,30′ ready to receive the spring 37 clips 34 that will hang the support on the ceiling of the vehicle. The pin consists of two parts mounted on a small spring 37 on which we show a shoulder line β; a spike end 35 inserting (following the dotted line) in the pinhole 30 and also in the fabric of the ceiling of the vehicle, and a non sharp end 35′ staying out of the hole and ready to be inserted into the core loop 29 so it does not unfold. The pinholes we are showing are sloping gently down α and are ending with a lip 31 offering a support on which the pin is resting exactly where the spring is located 37 and more specifically where the shoulder line is β (as shown in FIG. 6).

In addition to the surface with the pins, there is a cap 26 with a hinged flap 28 that can be folded up on the surface 24 to press against the pins and hold them against the ceiling so they move as little as possible. The cap is also hiding the pins for aesthetic reasons; by folding it 38′ and by blocking 40,41 its hinged flap 28 on the surface with the pins. Some recesses 27 in the cap are allowing you to press firmly on the pins when in closed position. A channel 38 acts as a hinge between the wedge-shaped holder 22 and the surface 24 with the pins, making it possible to adjust to concave or convex surfaces on the ceiling.

Some picks 32,32′,32″ are used to stabilize the box of tissues on the support. A second pin is inserted in the hole 30′.

FIG. 2 is showing a box 18 of tissues 42 fixed on the fabric 44 of the ceiling of a vehicle with holders 20-20′″. The holders are connected in pairs with elastic bands 36-36′ also making it possible to tighten the box of tissues. With the support 20 two pins can be seen 34,34′ to be inserted at a crossing angle in the fabric of the ceiling.

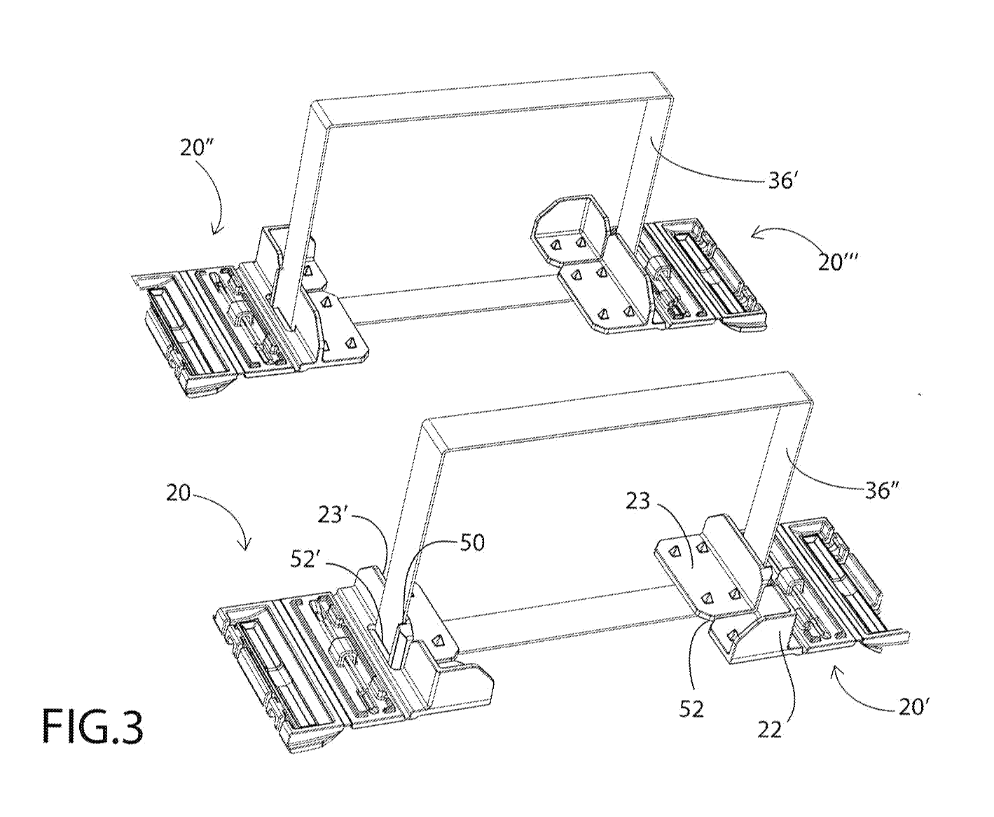

FIG. 3 is showing the four holders 20-20′″ with the elastic bands 36-36′ inserted into the wedge-shaped holders facing each other. The grooves of the elastic bands display an “L” shape intersecting 52 the tray 23 at the level of the corner 22 and extend 52′ behind the corner. When the elastic band is in position a loop 50 is holding it on the back of the corner to keep it from moving on the groove.

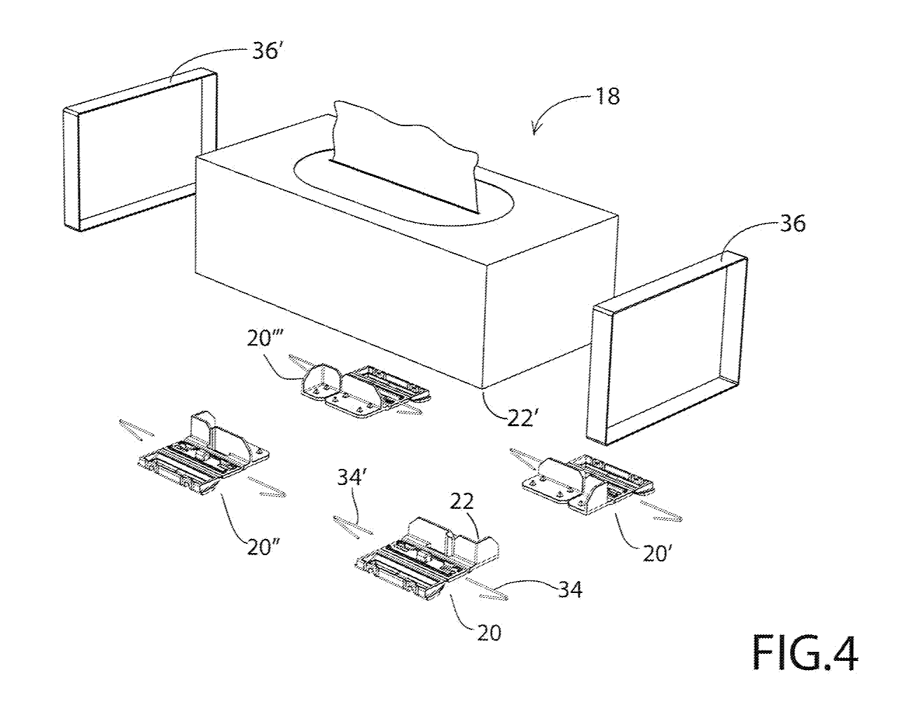

FIG. 4 is showing separately the holders 20-20′″, the elastics 36-36′, the box of tissues 18, and the pins displayed in pairs and ready to be installed on each holder can be seen more easily. The supports are installed such that their corner 22 embrace the corner 22′ of the box of tissue. The pins bend 34-34′ and permit the insertion at a crossing angle. Both the setting and their shape are making it possible to hold firmly the support when it gets fixed on the fabric of the ceiling of the vehicle; they also keep the pins from slipping.

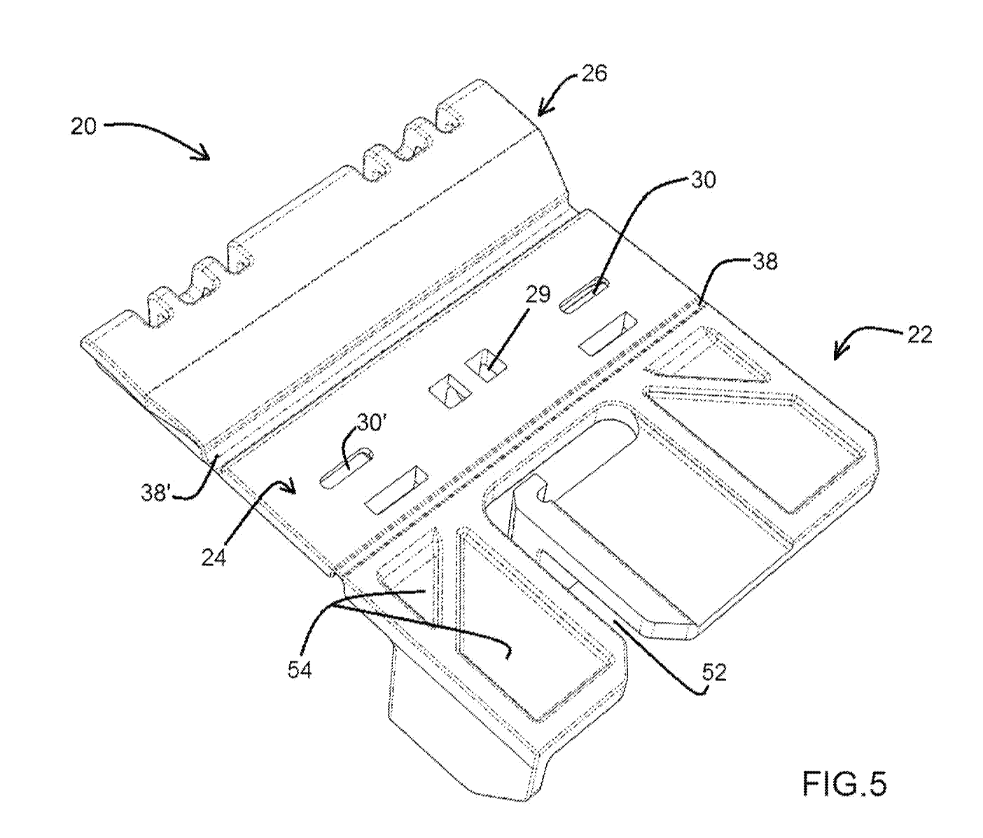

FIG. 5 is showing a view from underneath the support 20 consisting of the following three parts: the cap 26, the surface 24 with the pins with the pinholes 30 and the wedge-shaped holder 22 including the “L-shaped” groove for the elastic band 52 and the grooves 54 making the support more rigid. The channels 38,38′ work as hinges; the channel 38′ is allowing the cap to fold 26 on the pins, and the channel 38 works as a hinge between the wedge-shaped holder and the surface with the pins which is allowing the device to adapt to the unevenness of the ceiling showing some curves in certain areas. FIG. 5 is showing two small pinholes located under the holding loop 29 holding the pinhead to keep it from piercing the fabric of the ceiling.

FIG. 6 is showing an enlargement of the connection between the pin 34 made of steel, the lip 31 of the pinhole 30 made of plastic, and the recess 27 made of plastic. The pin is inserted 35′ in the fabric 44 of the ceiling of the vehicle, and is leaning on its shoulder β against the lip 31, then hold in place by the recess 27 pressing the non sharp end 35′ of the pin.

FIG. 7 is showing an enlarged back view from a pin that has been inserted in the fabric 44 of the ceiling of the vehicle. The spring 37 of the pin can be seen and more specifically its shoulder line β sitting on the lip of the pinhole.

### SUMMARY

In combination with means of pins 34-34′, a set of holders or supports 20-20′″ are used to fix a box of tissues to a ceiling of a vehicle; each support embrace a corner 22′ of the box on the three planes forming the corner.

The support is wedge-shaped and comprise three planes; two of the three planes form a corner 22 of the support and the third plane 23 perpendicular to the two planes is extending beyond the corner 22 and form a flat face 24 comprises holes to insert the pins. The third plane further extends beyond the flat face and forms a recessed shape 26 ending with hinged flap 28.

The holders 20 of our invention come preferably in sets of four.

More precisely:

the corner 22 is forming readily around the corner of a box of tissues. That part they take the triangular shape of the corners of a box of tissues.

in addition to the wedge-shaped holder, there is a face 24 having holes 30-30′ to receive the pins 34-34′ to fix the support to the fabric of the ceiling of the vehicle. The holes are normally even but preferably angled α with an ideal angle of 45°; the holes end with a lip 31 on which the pin is resting.

The pins are first inserted in the holes of the above-mentioned face, and then in the fabric of the ceiling of the passenger compartment of a vehicle. The pins are used preferably in pairs in each holder and they bend 37 to be inserted at a crossing angle in the fabric of the ceiling. A loop 29 is keeping the pin bent. The pins predominantly used are spring clips or any spring-loaded pin.

A cap 26 is used in addition to the face with the pins; that cap can be folded on the face with the pins in order to hide them which is adding to the aesthetics of the support. The cap ends with a hinged flap 28 to hold firmly the cap when it is folded on the surface with the pins, the hinged flap being inserted into the channel 38.

Elastic bands 36-36′ are surrounding the box of tissues and are providing support to the pairs of holders. These elastic bands are inserted into the support by a groove 52 usually in a “L” shape which is intersecting the corner tray 23 and extending 52′ behind the corner. A loop 50 is holding the elastic band in the back of the corner to keep it from moving in the groove once correctly installed.

The pin 34 consists of two parts 35,35′, like lines, with a spring 37:

the first one: a spike end 35 is going through the pinhole and then into the fabric of the ceiling of the vehicle to fix the support on the ceiling;

the second line 35′ stays on the top of the pinhole and is inserted in the core loop 29 in order to keep it folded.

These two parts are connected to each other with the spring 37 whose shoulder line β is resting against the lips 31 of the pinhole. The lip of the pinhole acts like a seal on which the shoulder β of the pin is resting. This support is firmly keeping in place the two ends of the pin, keeping the pin from slipping into the hole.

The channel 38 acts as a hinge and can bend so the face supporting the pins 24 adopts an angled-position allowing it to better adapt to the unevenness of the ceiling. The channel can bend up to an angle of 120° between the corner and the face supporting the pins. Similarly, the cap 26 can bend 38′.

The cap 26 has two functions:

when it is closed, it blocks the pins inside; its recesses 27 pushing against the pins over their entire length 35′ or just on the pinhead are keeping them in place inside the cap.

in addition, it has an aesthetic function (i.e. hiding the pins).

Grooves 54 are found at the back of the support in order to make it more rigid. It is to be clearly understood that the instant description with reference to the annexed drawing is made in an indicative manner and that the preferred embodiments described herein are meant in no way to limit further embodiments realizable within the scope of the invention.

PARTS

| | |
|---|---|
| 18 | Tissues |
| 20-20′″ | Support for box of tissues |
| 22 | Corner of the support |
| 22′ | Corner of the box of tissue |
| 23 | Tray of the support |
| 24 | Surface supporting the pins |
| 26 | Cap |
| 27 | Recesses |
| 28 | Hinged flap |
| 29 | Holding loop of the pin |
| 30-30′ | Pinholes |
| 31 | Lip in the pinhole |
| α | Angled lip |
| 32-32″ | Supporting picks |
| 34-34′ | Pins |
| β | Shoulder of the pin |
| 35, 35′ | Spike ends and non sharp end of the pin |
| 36-36′ | Elastic |
| 37 | Spring of the pin |
| 38 | First channel between the wedge-shaped holder |
| | and the surface with pins |
| 38′ | Folding channel for the cap |
| 40-41 | Means to secure the cap in closed position 26 |
| 42 | Tissues |
| 44 | Fabric from the ceiling of a vehicle |
| 50 | Holding loop for the elastic |
| 52 | Groove for the elastic |
| 54 | Grooves |

I claim:

1. In combination with means of pins (34,34′), a support (20) for boxes of tissues intended to be fixed to a ceiling of a vehicle, said support embracing a corner (22′) of said box on three planes of said corner (22′), said support being provided with holes (30) wherein said pins are inserted into said holes and further inserted into a fabric (44) of said ceiling of said vehicle.

2. The combination of claim 1 wherein said pin (34) is curved and is inserted at a crossed angle in said fabric of said ceiling, said pin consists of two parts defining two straight lines connected to each other with a curve (β), and at least one of said straight lines is pointed or sharp.

3. The combination of claim 2 wherein said support is wedge-shaped and comprises three planes wherein two of said three planes form a corner (22) of said support, a third plane (23) is normal to said two planes, said third plane is extending beyond said corner (22) and forms a flat face (24), said face comprising said holes of said pins, said third plane further extends beyond said face (24) and forms a recessed shape (26) ending with hinged flap (28).

4. The combination of claim 3 wherein said support is comprising a channel (38) defining a folding line between said corner (22) and said flat face (24), and a second channel (38′) defining a folding line between said flat face (24) and said recessed shape (26) and making it possible to fold said recessed shape on said flat face (24), thus permitting to cover said flat face as well as said pins for aesthetic purposes, means to block (40,41) said recessed shape against said flat face are preserving the aesthetical look.

5. The combination of claim 2 wherein said holes are angled (α) and are defining a shoulder against which said curve (β) of said pin is resting, thus stabilizing said two ends of said pin and keeping said pin from slipping in said hole.

6. The combination of claim 5 wherein said angle is set at 45°.

7. The combination of claim 1 wherein a holder is used for each of corners of said box of tissues.

8. The combination of claim 7 wherein said holders are used in pairs along with elastic bands (36,36′) surrounding said box of tissues at both ends, tightening said box of tissues against the corresponding holders.

9. The combination of claim 8 wherein said elastic bands are inserted in said support in recessed grooves.

10. The combination of claim 9 wherein said grooves are “L-shaped” dug crosswise on said third plane (23) and extending lengthwise along said corner (22).

11. The combination of claim 2 wherein said curved pin is as a matter of fact a spring clip.
